(19) United States
(12) Patent Application Publication
(10) Pub. No.: US 2014/0244513 A1
(43) Pub. Date: Aug. 28, 2014

(54) DATA PROTECTION IN NEAR FIELD COMMUNICATIONS (NFC) TRANSACTIONS

(71) Applicant: Miguel Ballesteros, Roseville, CA (US)

(72) Inventor: Miguel Ballesteros, Roseville, CA (US)

(21) Appl. No.: 13/774,031

(22) Filed: Feb. 22, 2013

(51) Int. Cl. G06Q 20/38

(52) U.S. Cl. CPC G06Q 20/382
USPC 705/64

(57) ABSTRACT

Described herein are architectures, platforms and methods for protecting sensitive data that are utilized during near field communications (NFC) communications or transactions and more particularly, a system on chip (SOC) microcontroller that is configured to control processing of the sensitive data during the NFC transactions is described. The sensitive data may include, but not limited to, personal information, financial information, or business identification numbers.

### BACKGROUND

As Near Field Communications (NFC) transceivers gain popularity across mobile devices, applications that make life more convenient are being introduced. In particular, mobile commerce allows users to conduct transactions using NFC. For example, a point of sale (POS) may be able to read a NFC enabled device such a credit card, allowing a consumer to complete a transaction with a seller. Such mobile commerce is expanding, allowing other NFC reader devices, such as laptop computers, tablets, mobile phones, etc. to read NFC enabled target devices, such as smart cards, credit cards and mobile phones to complete a transaction.

Typical NFC enabled reader architectures may be vulnerable to malware and malicious software that can steal sensitive data/information and fraudulently use such data/information. A central processing unit (CPU) running on the NFC enabled reader device may be subjected to malware and malicious software. An infected CPU may compromise the sensitive data/information.

NFC architectures may rely on particular modular elements/devices, such as interchangeable systems on a chip (SOC), NFC controllers, secure element components, etc. Furthermore, software running on a NFC architectures may rely on specific protocols, flows, and communications within such NFC architectures. Therefore, it is a challenge to provide solutions that protect sensitive NFC target data/information, and are compatible with NFC enabled architectures.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is an example scenario that illustrates near field communications (NFC) arrangement of devices to implement data protection during NFC related functions or transactions.

FIG. 2 is an example system of a portable device that implements data protection during near field communications (NFC) transactions.

FIG. 3 is a diagram of an example system for implementing data protection during near field communications (NFC) transactions.

FIG. 4 shows an example process chart illustrating an example method for data protection during near field communications (NFC) transactions.

### DETAILED DESCRIPTION

Described herein are architectures, platforms and methods for protecting sensitive data that are utilized during near field communications (NFC) communications or transactions, and more particularly a system on chip (SOC) microcontroller configured to control processing of the sensitive data during the NFC transactions is described. The sensitive data may include, but not limited to, personal information, financial information, or business identification numbers.

In an implementation, a portable device may enter into an NFC transaction by communicating or reading sensitive data from another portable device or NFC enabled object such as a credit card. The sensitive data may be exposed to possible malware at host software (i.e., software running on the central processing unit) in the portable device. To this end, the SOC microcontroller is installed at the portable device to control processing of the sensitive data during NFC transactions.

As an example of present implementations herein, the SOC microcontroller includes a central processing unit (CPU), a data interface such as an inter-integrated circuit (I2C) controller or serial peripheral interface bus (SPI) controller (or similar controller), and a system controller unit (SCU) that couples the CPU to the data interface. Additionally, the SOC microcontroller includes a security engine for internal encrypting and decrypting of sensitive data in the SOC microcontroller. For example, the security engine encrypts or decrypts sensitive data received from a target device.

As an example of present implementations herein, the CPU is configured to handle encrypted sensitive data that are received from the SCU. In this example, the SCU is configured as a “proxy server” to the CPU in processing of the sensitive data during the NFC transaction. For example, the SCU may receive the sensitive data from the credit card and instead of passing the sensitive data to the CPU or to the host software, the SCU routes the sensitive data to the security engine for encryption. In this example, the encrypted sensitive data communicated by the SCU to the CPU for utilization is protected from possible malware or suspicious applications accessing the CPU, since the sensitive data is encrypted.

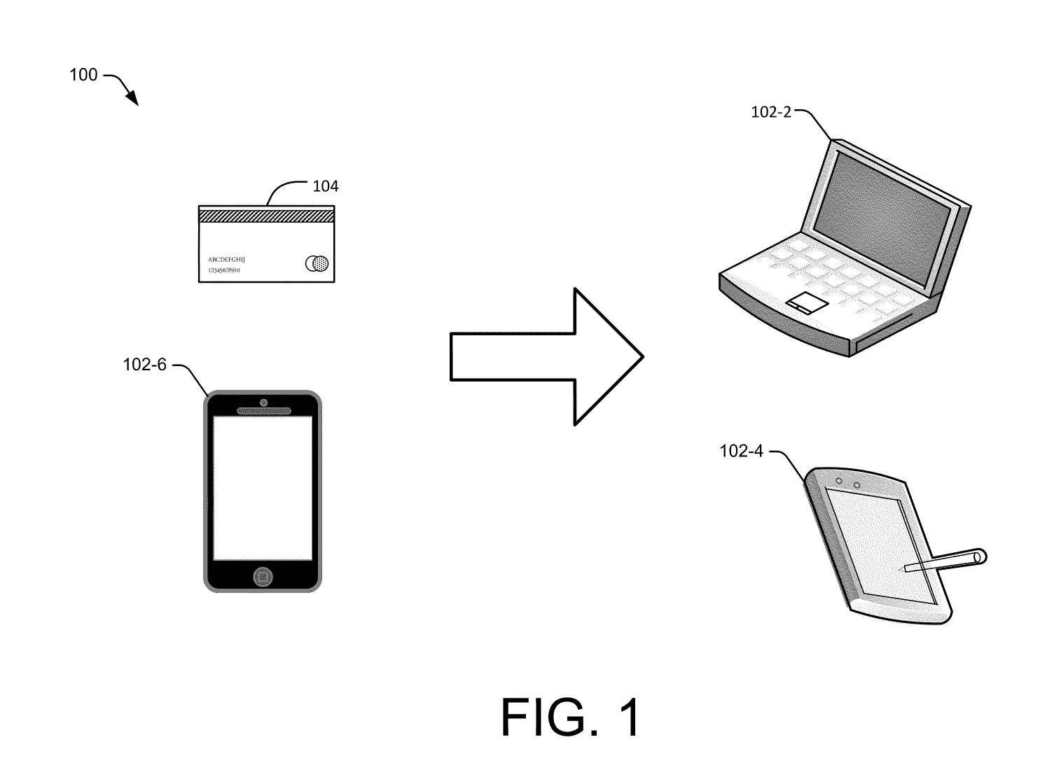

FIG. 1 is an example scenario 100 that illustrates NFC arrangement of portable devices to implement data protection during NFC related functions or transactions. Scenario 100 may include portable devices 102 and a credit card 104 in near field coupling arrangements.

As an example of present implementation herein, the example portable devices 102 may include, but are not limited to, Ultrabooks, a tablet computer, a netbook, a notebook computer, a laptop computer, mobile phone, a cellular phone, a smartphone, a personal digital assistant, a multimedia playback device, a digital music player, a digital video player, a navigational device, a digital camera, and the like. In this example, the example portable devices 102 may include a NFC antenna (not shown) that is utilized for near field coupling functions such as NFC communications, wireless power transfer (WPT), Europay MasterCard and Visa (EMV) transactions, and the like.

As an example of the present implementation, portable devices 102-2 and/or 102-4 may enter into EMV transactions with the credit card 104. In this example, the portable devices 102-2 and/or 102-4 may establish near field coupling with the credit card 104 by positioning the credit card 104 at a certain distance to its respective NFC antenna. At this certain distance, a principle of mutual induction in NFC communications is applied to communicate sensitive data between the credit card 104 and the portable devices 102-2 and/or 102-4. Similarly, the same principle may be applied when a portable device 102-6 is utilized in communicating sensitive data to the portable devices 102-2 and/or 102-4.

The data may include sensitive data such as personal, financial, or business information that needs additional protection against malware attacks. In this example, the portable devices 102 are configured to detect which data are sensitive data and which data are not. For the sensitive data, the portable devices 102 are configured to isolate processing of the sensitive data before they are exposed on the clear (i.e., unencrypted) at one or more processors or CPUs (not shown) or host software in the portable devices 102. In this manner, the sensitive data that are utilized during the NFC communications are protected from malicious programs that are capable of stealing the sensitive data from the portable devices 102.

The portable devices 102 may include a SOC microcontroller (not shown) coupled to other device components (not shown) to implement data protection during the NFC transactions. In this example, the SOC microcontroller is configured to control processing of the sensitive data in the portable devices 102 during the NFC transactions. In other words, this configuration of the SOC microcontroller allows the SOC microcontroller to act as a main controller for processing of the sensitive data.

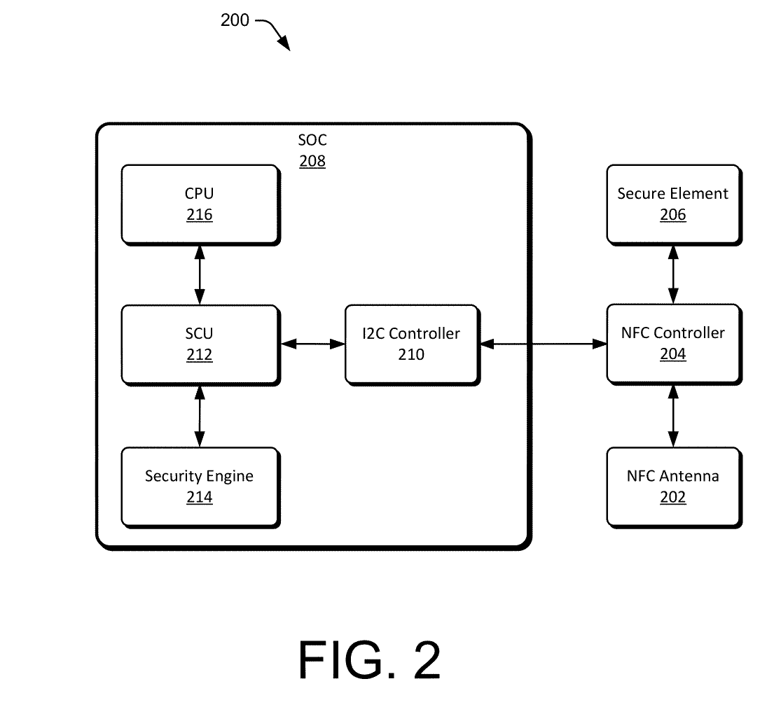

FIG. 2 illustrates an example system 200 of the portable device 102 that implements data protection during NFC transactions or communications. As shown, the system 200 includes an NFC antenna 202, an NFC controller 204, a secure element 206, and a SOC 208. Furthermore, the SOC 208 may include an inter-integrated circuit (I2C) controller 210 (it is to be understood that other controllers may be used, such as a serial peripheral interface (SPI) bus controller), a system controller unit (SCU) 212, a security engine 214, and a CPU 216.

As an example of current implementation herein, the NFC antenna 202 may include a coil antenna that may be made out of a printed circuit board (PCB), a flexible printed circuit (FPC), a metal wire, or created through a laser direct structuring (LDS) process. In this example, the NFC antenna 202 may be configured to operate on a resonant frequency (e.g., 13.56 MHz to implement NFC and/or WPT operations), and independent from another transceiver antenna that uses another frequency for wireless communications (e.g., 5 GHz for Wi-Fi signals). In an implementation, the NFC antenna 202 transmits or reads the sensitive data from the credit card 104. In this implementation, the sensitive data may be communicated to the SOC 208 through the NFC controller 204.

As an example of present implementation herein, the NFC controller 204 is configured as a router for the SOC 208. For example, data from the SOC 208 may be routed from either the NFC antenna 202 or to the secure element 206. In this example, the SOC 208 and more particularly, the SCU 212 may decide whether the sensitive data will be routed from the NFC antenna 202 or to the secure element 206. In a scenario where the SCU 212 decides to have the sensitive data processed by an external component or a computing device such as the secure element 206, then the sensitive data will be routed to the secure element 206 by the NFC controller 204.

As an example of present implementation herein, the secure element 206 is a secure and isolated execution environment for the sensitive data to be processed. For example, the secure element 206 is a component or a computing device that is external to the SOC 208. In other words, the secure element 206 is configured to process sensitive data independent of the SOC 208; however, the request to process the sensitive data is generated by the SOC 208 and particularly, the SCU 212. Upon processing of the sensitive data, the secure element 206 may supply the processed sensitive data back to the SOC 208 through the NFC controller 204. In an implementation, the secure element 206 is software/hardware tamper resistant such that transferring of sensitive data to a secure server is implemented via a secure channel (not shown).

The I2C controller 210 is configured as a data interface between the SCU 212 and the NFC controller 204 that is external to the SOC 208. In this example, the I2C controller 210 is controlled directly by the SCU 212. In other words, the CPU 216 does not have direct access to the I2C controller 210. In an implementation, the I2C controller 210 is a two-wire, bidirectional serial bus that provides a simple, efficient method of sensitive data exchange between the SOC 208 and the NFC controller 204. In this implementation, the I2C controller 210 is configured to be an ingress and egress of the sensitive data in the SOC 208. Although the example of FIG. 2 utilizes the I2C controller 210 in the current embodiment, other types of data interface may be utilized to connect the SCU 212 to components external to the SOC 208.

The SCU 212 may be configured as a gateway for communications of sensitive data between the CPU 216 and components that are external to the SOC 208 such as the NFC controller 204, the secure element 206, and the NFC antenna 202. For example, the SCU 212 may be configured to be a proxy controller for the CPU 216 to implement sensitive data protection during the NFC transaction. In this example, the SCU 212 is configured to determine which data are sensitive and which are not.

For example, when the SCU 212 determines that particular data (e.g., credit card account number) is sensitive, then the SCU 212 directs encryption of this data before sending the data to the CPU 216. In this example, the determined sensitive data are not directly exposed to possible data risks (e.g., malware) at the CPU 216, since the sensitive data is encrypted.

In instances where the CPU 216 sends the encrypted sensitive data to the secure element 206, the SCU 212 is configured to control decryption of the encrypted sensitive data before the SCU 212 sends the sensitive data to the secure element 206 for further processing. In other words, the SCU 212 is configured to maintain encryption of sensitive data that is received by the CPU 216. However, the SCU 212 is configured to maintain data in the clear (i.e., unencrypted data) at the I2C controller 210 interface, where such data in the clear is sent to the secure element 206.

In another implementation, the SCU 212 does not pass the sensitive data to the host or CPU 216, but rather the SCU 212 redirects or routes directly the sensitive data to the secure element 206. In this implementation, data encryption is not necessary since the host or CPU 216 will not receive the sensitive data.

In the implementations described above, the secure element 206 may receive the data as clear text (i.e., unencrypted data). However, in the instances where the SCU 212 sends the sensitive data to the CPU 216, there is minimal or no changes that may be implemented on the existing application software running on the CPU 216. Contrast this with the SCU 212 routing directly the sensitive data to the secure element 206, the existing application software running on the CPU 216 and the secure element 206 need to be adjusted such that sensitive data is protected from malware accessing the CPU 216.

The security engine 214 may be coupled to the SCU 212 within the SOC 208. In this implementation, the security engine 214 is configured to encrypt or decrypt sensitive data. For example, when the CPU 216 sends encrypted sensitive data to the secure element 206, the SCU 212 receives the encrypted sensitive data and allows the security engine 214 to decrypt this encrypted sensitive data before forwarding it to the secure element 206. In another example, the SCU 212 controls encryption of the sensitive data that are received by the CPU 216 by first routing the sensitive data to the security engine 214 for encryption before forwarding the same to the CPU 216 for processing.

As an example of present implementation herein, the CPU 216 may host an NFC stack and applications processing sensitive data for NFC transactions. For example, the CPU 216 is configured to handle encrypted sensitive data so that malware will not be able to interpret it. Actual processing of the sensitive data may be implemented in isolation at the secure element 206.

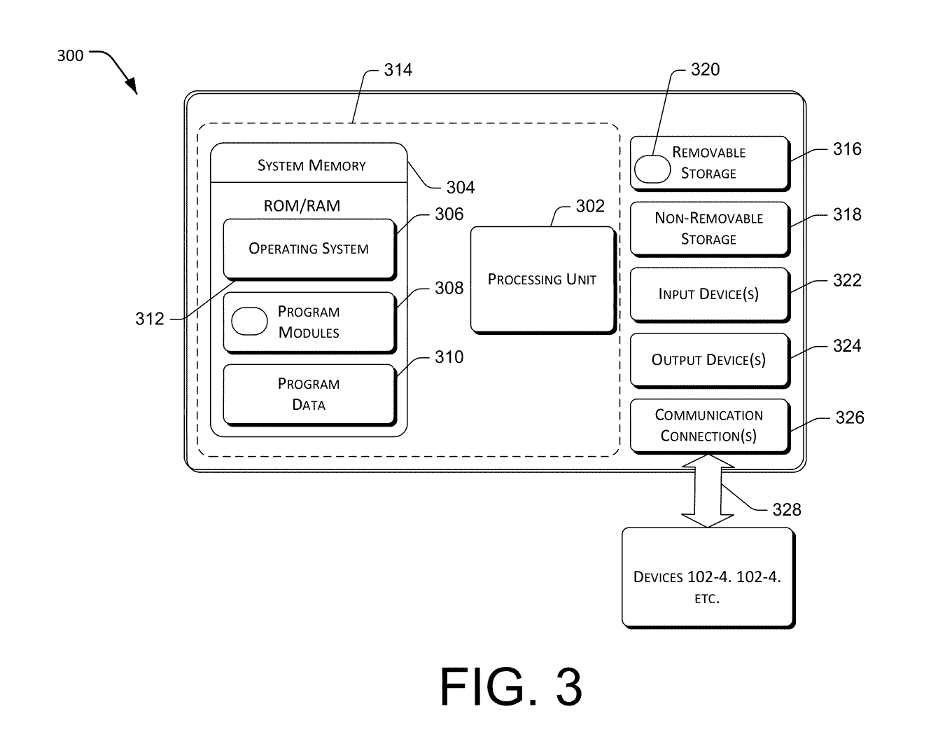

FIG. 3 is an example system that may be utilized to implement various described embodiments. However, it will be readily appreciated that the techniques disclosed herein may be implemented in other computing devices, systems, and environments. The computing device 300 shown in FIG. 3 is one example of a computing device and is not intended to suggest any limitation as to the scope of use or functionality of the computer and network architectures.

In at least one implementation, computing device 300 typically includes at least one processing unit 302 and system memory 304. Depending on the exact configuration and type of computing device, system memory 304 may be volatile (such as RAM), non-volatile (such as ROM, flash memory, etc.) or some combination thereof. System memory 304 may include an operating system 306, one or more program modules 308 that implement the long delay echo algorithm, and may include program data 310. A basic implementation of the computing device 300 is demarcated by a dashed line 314.

The program module 308 may include a module 312 configured to implement the one-tap connection and synchronization scheme as described above. For example, the module 312 may carry out one or more of the method 300, and variations thereof, e.g., the computing device 300 acting as described above with respect to the device 102.

Computing device 300 may have additional features or functionality. For example, computing device 300 may also include additional data storage devices such as removable storage 316 and non-removable storage 318. In certain implementations, the removable storage 316 and non-removable storage 318 are an example of computer accessible media for storing instructions that are executable by the processing unit 302 to perform the various functions described above. Generally, any of the functions described with reference to the figures may be implemented using software, hardware (e.g., fixed logic circuitry) or a combination of these implementations. Program code may be stored in one or more computer accessible media or other computer-readable storage devices. Thus, the processes and components described herein may be implemented by a computer program product. As mentioned above, computer accessible media includes volatile and non-volatile, removable and non-removable media implemented in any method or technology for storage of information, such as computer readable instructions, data structures, program modules, or other data. The terms “computer accessible medium” and “computer accessible media” refer to non-transitory storage devices and include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium that may be used to store information for access by a computing device, e.g., computing device 300 and wireless mobile device 102. Any of such computer accessible media may be part of the computing device 300.

In one implementation, the removable storage 316, which is a computer accessible medium, has a set of instructions 330 stored thereon. When executed by the processing unit 302, the set of instructions 330 cause the processing unit 302 to execute operations, tasks, functions and/or methods as described above, including method 300 and any variations thereof.

Computing device 300 may also include one or more input devices 320 such as keyboard, mouse, pen, voice input device, touch input device, etc. Computing device 300 may additionally include one or more output devices 322 such as a display, speakers, printer, etc.

Computing device 300 may also include one or more communication connections 324 that allow the computing device 300 to communicate wirelessly with one or more other wireless devices, over wireless connection 328 based on near field communication (NFC), Wi-Fi, Bluetooth, radio frequency (RF), infrared, or a combination thereof.

It is appreciated that the illustrated computing device 300 is one example of a suitable device and is not intended to suggest any limitation as to the scope of use or functionality of the various embodiments described.

Unless the context indicates otherwise, the term “Universal Resource Identifier” as used herein includes any identifier, including a GUID, serial number, or the like.

In the above description of example implementations, for purposes of explanation, specific numbers, materials configurations, and other details are set forth in order to better explain the present invention, as claimed. However, it will be apparent to one skilled in the art that the claimed invention may be practiced using different details than the example ones described herein. In other instances, well-known features are omitted or simplified to clarify the description of the example implementations.

The inventors intend the described example implementations to be primarily examples. The inventors do not intend these example implementations to limit the scope of the appended claims. Rather, the inventors have contemplated that the claimed invention might also be embodied and implemented in other ways, in conjunction with other present or future technologies.

Moreover, the word “example” is used herein to mean serving as an example, instance, or illustration. Any aspect or design described herein as “example” is not necessarily to be construed as preferred or advantageous over other aspects or designs. Rather, use of the word example is intended to present concepts and techniques in a concrete fashion. The term “techniques”, for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more”, unless specified otherwise or clear from context to be directed to a singular form.

These processes are illustrated as a collection of blocks in a logical flow graph, which represents a sequence of operations that may be implemented in mechanics alone or a combination with hardware, software, and/or firmware. In the context of software/firmware, the blocks represent instructions stored on one or more computer-readable storage media that, when executed by one or more processors, perform the recited operations.

Note that the order in which the processes are described is not intended to be construed as a limitation, and any number of the described process blocks may be combined in any order to implement the processes or an alternate process. Additionally, individual blocks may be deleted from the processes without departing from the spirit and scope of the subject matter described herein.

The term “computer-readable media” includes computer-storage media. In one embodiment, computer-readable media is non-transitory. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

Unless the context indicates otherwise, the term “logic” used herein includes hardware, software, firmware, circuitry, logic circuitry, integrated circuitry, other electronic components and/or a combination thereof that is suitable to perform the functions described for that logic.

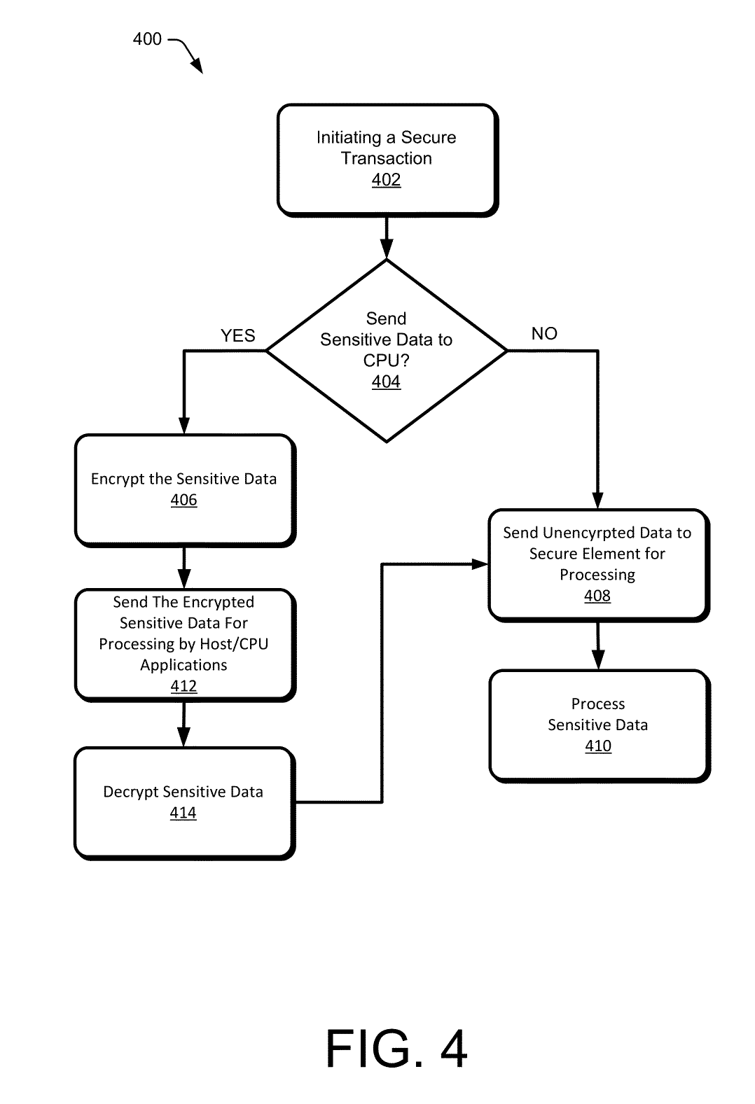

FIG. 4 shows an example process chart 400 illustrating an example method for sensitive data protection during an NFC transaction. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 402, initiating a secure transaction application is performed. For example, a SOC (e.g., SOC 208) may include a CPU (e.g., CPU 216) that is configured to host an NFC stack and applications processing of data during an NFC transaction. In this example, the data may include sensitive data received from a target device, such as a credit card or a smartphone. In an implementation, the CPU 216 may initiate the secure transaction application. For example, the secure transaction application includes receiving of sensitive data from the target device, such as a credit card or smartphone.

At block 404, determining if the SCU sends the sensitive data to CPU is performed. For example, the SCU 212 is configured to send the sensitive data to the CPU 216 or to a component external to the SOC 208 such as a secure element (e.g., secure element 206). If the SCU 212 sends the sensitive data to the CPU 216, then following “YES” branch at block 406, the SCU 212 controls encryption of the sensitive data. Alternatively, if the SCU 212 sends or routes directly the sensitive data to a component external to the SOC 208 such as the secure element 206, then following “NO” branch at block 408, the SCU 212 allows unencrypted sensitive data to be forwarded to the secure element 206 for further processing.

In the examples described above, the SCU 212 is configured to filter processing of the sensitive data without affecting or disturbing usages or other data that do not require further processing by the secure element 206 such as reading NFC tags or Peer-2-Peer transactions.

At block 410, processing of the sensitive data is performed by a secure element.

At block 412, sending of encrypted sensitive data is performed. For example, if the SCU 212 sends the sensitive data to the CPU 216, the SCU 212 is configured to all encryption of the sensitive data before it is forwarded by the SCU 212 to the CPU 216. The encryption may be performed by a security engine as described above. The encrypted sensitive data is now protected from any malicious software or malware accessing the CPU.

At block 414, decryption of sensitive data that the CPU sends to the secure element is performed. For example, when the CPU 216 sends encrypted sensitive data to the secure element 206 for further processing, the SCU 212 first controls decryption of the encrypted sensitive data before forwarding the same to the secure element 206. That is, the SCU 212 allows the security engine 214 to perform decryption of the encrypted sensitive data so that data in the clear passes through the I2C controller 210 going to the secure element 206.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A system on chip (SOC) comprising:
a central processing unit (CPU) configured to detect and process a secure transaction, wherein the secure transaction includes sensitive data;
a system controller unit (SCU) coupled with the CPU, wherein the SCU is configured to control encryption of the sensitive data when the sensitive data is received by the CPU and to control decryption of encrypted sensitive data; and
a security engine coupled to the SCU, wherein the security engine is configured to implement encryption or decryption of the sensitive data.

2. The SOC as recited in claim 1, wherein the CPU is configured to process encrypted sensitive data.

3. The SOC as recited in claim 1, wherein the SCU is configured to receive encrypted sensitive data previously encrypted by the security engine from the CPU, wherein the SCU sends the encrypted sensitive data to the security engine for decryption and sends decrypted sensitive data to an external secure element for processing.

4. The SOC as recited in claim 1, wherein the SCU is configured to receive the sensitive data from a target device, and in response to receiving the sensitive data, the SCU is configured to send the received sensitive data to a secure element for processing or sends the sensitive data for encryption to the security engine if the sensitive data is to be sent to the CPU for use by software applications hosted on the CPU.

5. The SOC as recited in claim 1, wherein the sensitive data includes personal information, financial identification, and/or business identification numbers.

6. The SOC as recited in claim 1, wherein the secure transaction includes an Europay MasterCard and Visa (EMV) transaction.

7. The SOC as recited in claim 1 further comprising a controller configured as an interface to receive and send sensitive data from the SOC.

8. The SOC as recited in claim 7, wherein the controller is one of an inter-integrated circuit (I2C) controller or serial peripheral bus (SPI) controller.

9. A device comprising:
a secure element configured to process sensitive data;
a near field communications (NFC) controller coupled to the secure element; and
a system on chip (SOC) coupled to the secure element by the NFC controller, the SOC comprising:
a central processing unit (CPU);
a data interface;
a system controller unit (SCU) that couples the CPU to the data interface, wherein the SCU is configured as a proxy controller to the CPU;
and a security engine coupled to the SCU configured to encrypt the sensitive data processed by the CPU, and decrypt previously encrypted sensitive data that the CPU sends to the secure element for further secure processing.

10. The device as recited in claim 9, wherein the CPU receives and processes the encrypted sensitive data from the SCU.

11. The device as recited in claim 9, wherein the data interface includes one of an inter-integrated circuit (I2C) controller, serial peripheral bus (SPI) controller, or other peripheral interface.

12. The device as recited in claim 9, wherein the SCU is configured to receive the sensitive data through the data interface and in response to receiving the sensitive data, the SCU is configured to send the received sensitive data to the secure element for processing or to the security engine for encryption, wherein decrypted sensitive data is sent to the CPU for processing.

13. The device as recited in claim 9, wherein the SCU is configured to filter the sensitive data in a secure transaction from other transactions that do not require further processing by the secure element.

14. The device as recited in claim 9, wherein the sensitive data includes personal information, financial identification, and/or business identification numbers.

15. The device as recited in claim 9, wherein the sensitive data is utilized during NFC transactions, the NFC transactions include Europay MasterCard and Visa (EMV) transactions.

16. The device as recited in claim 9 further comprising a security engine in the SOC, the security engine is controlled by the SCU to encrypt or decrypt sensitive data.

17. A method of protecting sensitive data during a near field communications (NFC) transaction, the method comprising:
initiating a secure transaction application that receives the sensitive data;
determining if a system controller unit (SCU) sends the sensitive data to a host central processing unit (CPU) or to a secure element;
encrypting the sensitive data by a security engine, if the SCU sends the sensitive data to the host CPU;
sending unencrypted sensitive data, if the SCU sends the sensitive data to the secure element; and
processing the unencrypted sensitive data by the secure element.

18. The method as recited in claim 17, wherein the initiating secure transaction application includes receiving of the sensitive data by the SCU through an inter-integrated circuit (I2C) controller or similar peripheral controller.

19. The method as recited in claim 17, wherein the sending an unencrypted sensitive data to the secure element includes decrypting an encrypted sensitive data that was previously encrypted by the security engine, wherein decrypted sensitive data is sent by the host CPU to the secure element via the SCU for further secure processing.

20. The method as recited by claim 17, wherein the sending of the sensitive data by the SCU to the secure element includes routing of the received sensitive data directly to the secure element rather than sending the received sensitive data to the CPU for processing.

21. The method as recited in claim 16, wherein the sensitive data includes personal information, financial identification, and/or business identification numbers that are utilized during the NFC transaction, the NFC transaction includes Europay MasterCard and Visa (EMV) transactions.

22. Machine readable storage medium including program code, when executed, cause a computing device to perform the method of:
initiating a secure transaction application that receives sensitive data from a target device;
determining if the sensitive data is to be encrypted or sent to a secure element as unencrypted data;
encrypting the sensitive data if the sensitive data is to used by a host central processing unit (CPU); and
sending unencrypted sensitive data for secure processing.

23. The machine readable storage medium of claim 22 further comprising decrypting previously encrypted sensitive data from the host CPU prior to sending the unencrypted sensitive data for secure processing.
